(19) United States
(12) Patent Application Publication
(10) Pub. No.: US 2025/0029235 A1
(43) Pub. Date: Jan. 23, 2025

(54) GENERATION ON OK MODEL BY MULTIPLE CONCEPTS

(71) Applicant: AI QUALISENSE 2021 LTD, Tel Aviv-Yafo (IL)

(72) Inventor: Karina Odinaev, Tel Aviv (IL)

(73) Assignee: AI QUALISENSE 2021 LTD, Tel Aviv-Yafo (IL)

(21) Appl. No.: 18/776,168

(22) Filed: Jul. 17, 2024

Related U.S. Application Data
(60) Provisional application No. 63/514,098, filed on Jul. 17, 2023.

(51) Int. Cl. G06T 7/00; G06T 7/10

(52) U.S. Cl. CPC G06T 7/001; G06T 7/10

(57) ABSTRACT

A method for detecting faulty manufactured items, the method includes segmenting an image of the evaluated MI to provide different groups of evaluated MI patches, generating evaluated MI patches representations (EMIPRs) for the evaluated MI patches of the different groups of evaluated MI patches; matching the EMIPRs to reference MI patches representations (RMIPRs) of reference MI patches, to provide comparison results; wherein the reference MI patches are selected from reference MI patches candidates, based on at least one of (a) a popularity of reference MI patch candidates representations or (b) feedback from a person; wherein reference MI patches of the different groups of reference MI patches differ from each other by one or more reference MI patch attribute; and determining a state of the evaluated manufactured item based on the comparison results.

### BACKGROUND OF THE INVENTION

Defect detection of manufactured items (MI) may be problematic when differently looking MIs may be regarded OK.

FIG. 1 illustrates an example of an OK MI that has a high surface variability—it includes differently looking parts that are all OK.

FIG. 2 illustrates different MIs that significantly differ from each other—exhibits a high variability—for example due to manufacturing parameters—but are all OK.

Under these conditions, it is very difficult to differentiate between OK and faulty MIs.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of prior art OK MI;

FIG. 2 illustrates an example of prior art OK MIs;

FIG. 3 illustrates an example of a method;

FIG. 4 illustrates an example of a method;

FIG. 5 illustrates an example of images of evaluated MIs;

FIGS. 6 and 7 illustrate different manners to segment an evaluated MI image;

FIG. 8 illustrates examples of various data structures; and

FIG. 9 illustrates a system according to an embodiment of the invention.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

There is provided a solution that includes using information regarding different groups of reference MI patches representations (RMIPRs) that represents different groups of OK reference MI patches—to search OK evaluated MI patches.

The search may be indifferent to location—thus allowing to find OK evaluated MI patches positioned at different locations. The different groups of RMIPRs may be found based on feedback from a person and/or based on the popularity of the reference MI patches—assuming that the manufacturing process mainly outputs OK MIs.

The different groups of RMIPRs may be found by clustering and does not require prior knowledge on the manufacturing process and/or the manufactured MIs—which provides technical benefits of simplifying and reducing the cost of the defect detection—and also enables to seamlessly perform the process on currently operations production lines.

It should be noted that the location of reference MI patches represented by the reference MI patches representations can be taken into account—and that the different RMIPRs groups can be generated while maintaining one or more locations of reference MI patches represented by the RMIPRs.

When a group of RMIPRs represents reference MI patches exhibits a certain locality (for example is associated with one location or below a threshold of locations)—then the matching may take into account this locality—for example by performing matches to evaluated MI patches of the same locality.

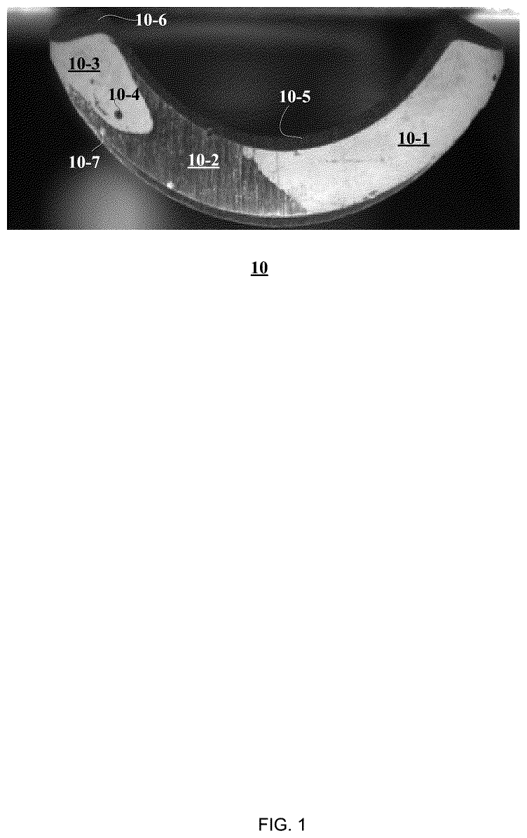

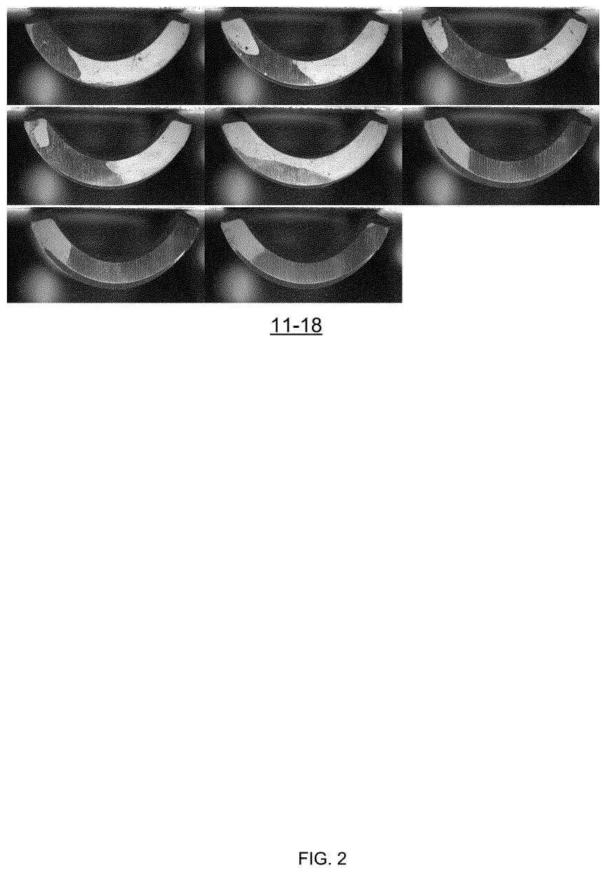

FIG. 1 illustrates method 100 for detecting faulty manufactured items.

Method 100 may start by step 110 of obtaining an evaluated manufactured item (MI) image.

Step 110 may be followed by step 120 of segmenting the image of the evaluated MI to provide different groups of evaluated MI patches, wherein evaluated MI patches of the different groups of evaluated MI patches differ from each other by one or more evaluated MI patch generation attribute.

An evaluated MI patch generation attribute is indicative of how the evaluated MI patches were generated. An evaluates MI patch generation attribute may be at least one of size of patch, shape of patch, overlap between adjacent patches and the like. For example, assuming rectangular patches of K different sizes—from N₁×M₁ pixels to N_{K}×M_{K} pixels, K being an integer that exceeds one. Yet for another example—having patches of different shapes—for example polygons of different numbers of facets, a combination of polygon patches and patches that have at least one non-linear part, and the like. Yet for a further example—some adjacent patches are non-overlapping while other patches are partially overlapping, or having different overlaps between different patches.

At least two of the different groups of the evaluated MI patches may cover an entirety of the evaluated MI. One or more groups of the evaluated MI patches may cover only a part of the evaluated MI.

There may be two, three or more different groups of evaluated MI patches.

Generating different groups of MI patches is beneficial as it may not be known in advance which type of patch will be able to distinguish between OK and faulty evaluated MIs.

Step 120 may be followed by step 130 of generating evaluated MI patches representations (EMIPRs) for the evaluated MI patches of the different groups of evaluated MI patches.

Step 130 may be followed by step 140 of matching the EMIPRs to reference MI patches representations (RMIPRs) of reference MI patches, to provide comparison results.

The RMIPRs may belong to different RMIPRs groups. The groups may be generated during a training process.

A RMIPRs group may have a group representation—that is shared by the members of the RMIPRs group—and not shared by members of other RMIPRs groups.

The matching may include comparing the EMIPRs to group representations—which is more efficient from a computational point of view.

The RMIPRs represent reference MI patches of the different groups of reference MI patches. The reference MI patches of the different groups of reference MI patches differ from each other by one or more reference MI patch attribute. The one or more reference MI patch attribute may be defined de-facto by a grouping of the RMIPR to RMIPR groups. Larger RMIPR groups include more members—and their members are deemed to be more popular.

Reference MI patches are selected from reference MI patches candidates.

The selection may be based on a popularity of reference MI patch candidates representations.

The selection may be based on feedback from a person—regardless of the popularity of reference MI patch candidates representations.

The selection may be based on the feedback from the person and on the popularity of reference MI patch candidates representations.

For example—the selection may include:
a. Determining, based on the popularity of reference MI patch candidates representations, popular reference MI patch candidates representations of the reference MI patch candidates representations.
b. Providing to the person information regarding the popular reference MI patch candidates representations.
c. Receiving feedback from the person regarding the popular reference MI patch candidates representations.
d. Selecting the reference MI patches based on the feedback.

Step 140 may be followed by step 150 of determining a state of the evaluated manufactured item based on the comparison results.

The state may be OK or faulty (NG). Alternatively—the state may include partially OK, and/or provide information about the level (out of more than two levels) of functionality of the evaluated MI, and/or provide indication about defects—for example number of defects, distribution of defects, having one or more problematic evaluated IM patch, and the like.

Step 150 may include determining that the evaluated manufactured item is faulty when the comparison results indicate that there is at least a predefined number of evaluated MI patch representations that does not match any of the reference MI patch representations. The predefined number may be determined in any manner—and may be based on a tradeoff between false/true negative/positive statistics. The strictest test will define a evaluated MI as faulty when even a single evaluated MI patch representation does not match any of the reference MI patch representations.

The matching is executed regardless of a location of the reference MI patch.

Step 150 may be followed by step 160 of responding to the determining.

The responding may include changing the manufacturing processes used to manufacture the evaluated MIs, requesting or instructing to changes the manufacturing processes, generating a defective evaluated MI alert, making available (by storing and/or transmitting) any information gained during the matching to the person or any other entity related to the manufacturing process, and the like.

The responding may performing one or more fault patch operations. The one or more faulty patch operation may include at least one of:
a. Classifying the EMIPRs of defective patches to classes to provide classes of defective patches representations.
b. Comparing the EMIPR obtained in future iterations of method 100 to the defective patches to classes—to provide information about newly defective patches.

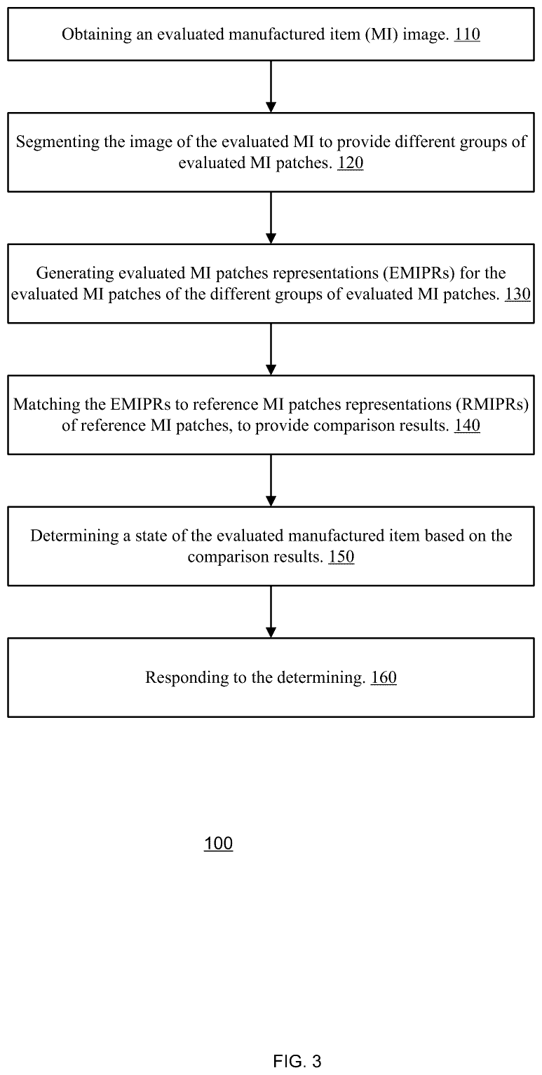

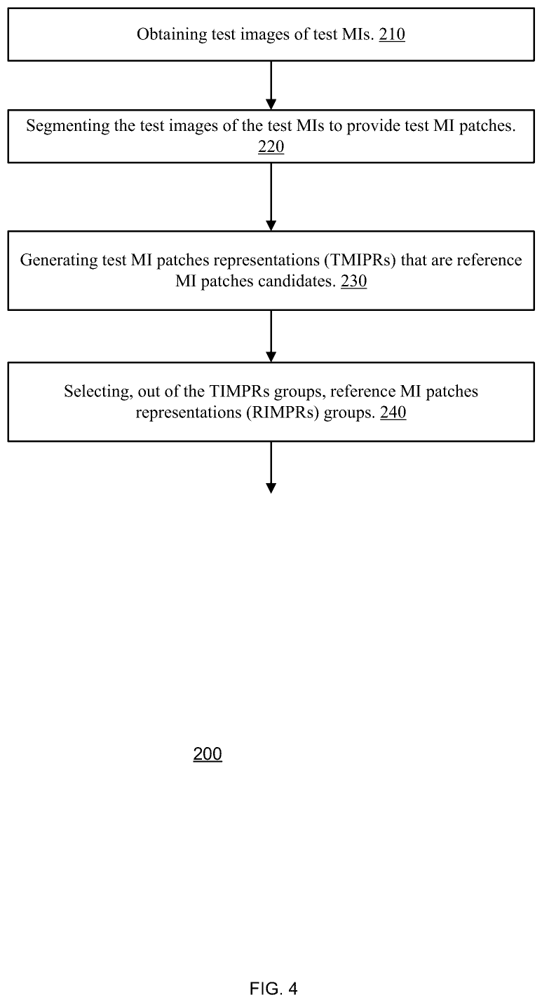

FIG. 3 illustrates method 200 for generating reference MI patch candidates.

Method 200 may start by step 210 of obtaining test images of test MIs.

Step 210 may be followed by step 220 of segmenting the test images of the test MIs to provide test MI patches.

The test images may be unlabeled—thus do not include metadata regarding defects. One or more of the test images may be labeled.

The segmenting of step 220 may be done in the same manner as step 120—segmenting the test images to provide different groups of test MI patches, wherein test MI patches of the different groups of test MI patches differ from each other by one or more test MI patch generation attribute. The one or more test MI patch generation attribute may equal the one or more evaluated MI patch generation attribute.

Step 220 may be followed by step 230 of generating test MI patches representations (TMIPRs) that are reference MI patches candidates.

Step 220 may be followed by step 230 of grouping the TIMPRs to provide TIMPRs groups that are reference MI patches candidates groups.

Step 230 may be followed by step 240 of selecting, out of the TIMPRs groups, reference MI patches representations (RIMPRs) groups.

Step 240 may include selecting is based on the at least one of (a) the popularity of the reference MI patch candidates representations or (b) the feedback from the person.

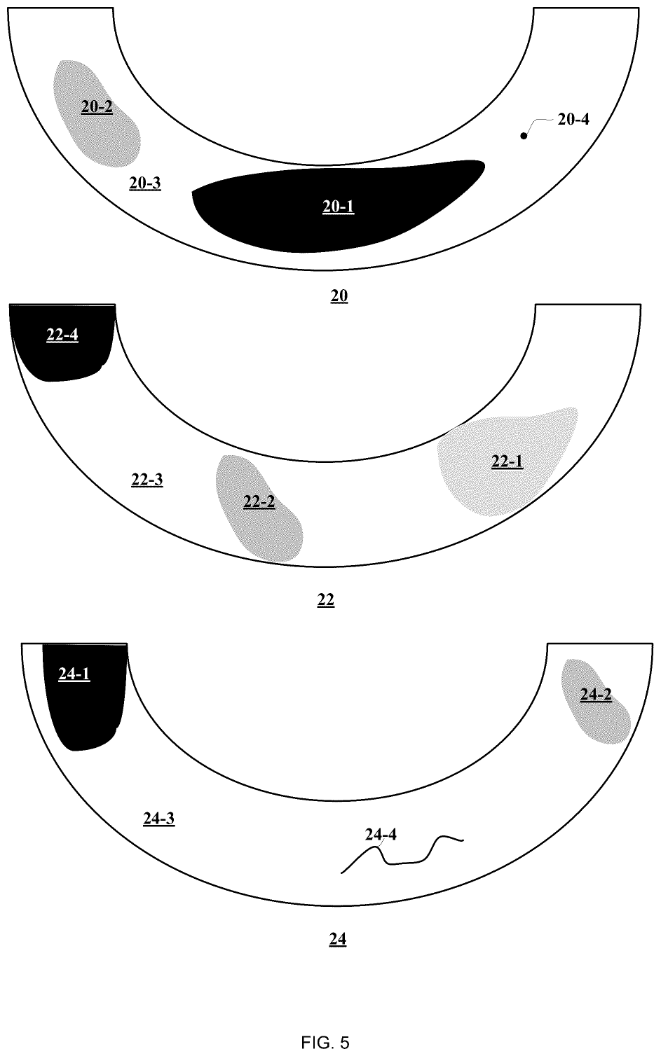

FIG. 5 illustrates an example of images of evaluated MIs 20, 22 and 24. First evaluated MI 20 and second evaluated MI 22 are OK, while third evaluated MI 24 is faulty—as it includes defect 24-4. FIG. 5 also illustrates that the MIs include regions (20-1, 20-2, 20-3, 20-4, 21-1, 21-2, 21-3, 21-4, 22-1, 22-2, 22-3 and 22-4) of different shape and/or size and/or location and/or color—whereas most of these regions should not prevent the defect detection process to determine the faulty and the OK evaluated MIs.

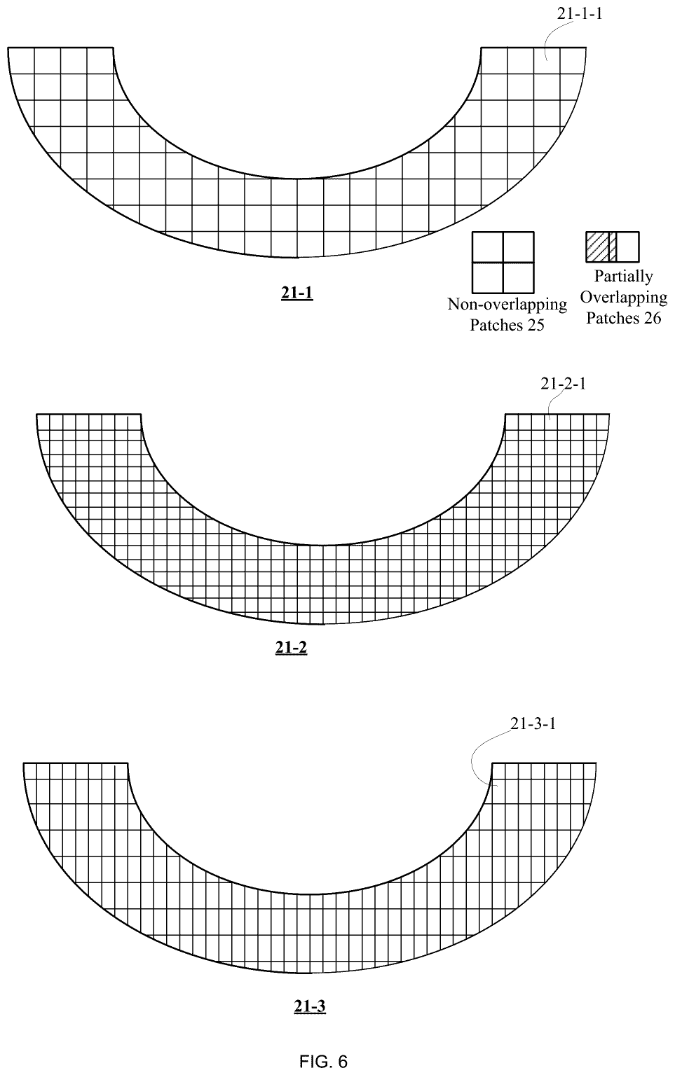

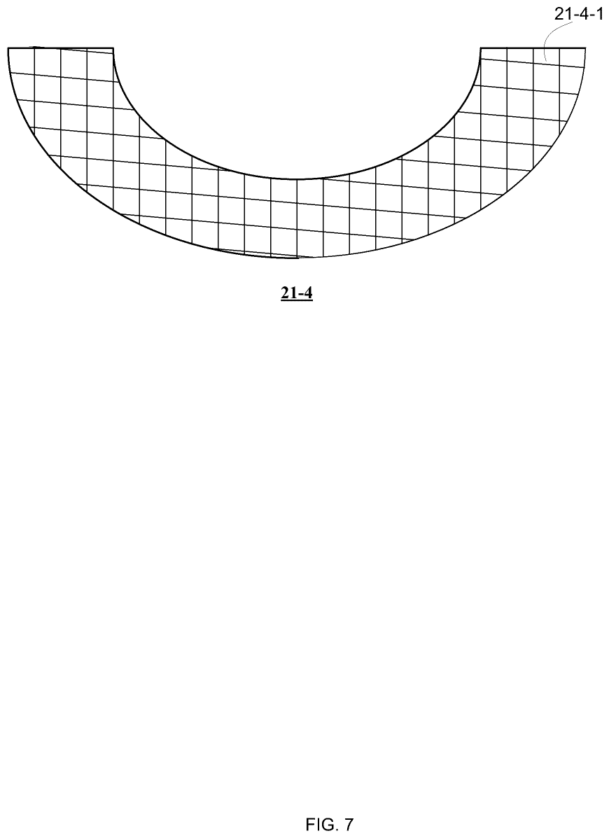

FIGS. 6 and 7 illustrate different manners to segment an evaluated MI image (21-1, 21-2, 21-3 and 21-4) to provide patches (such as 21-1-1, 21-2-1, 21-3-1 and 21-4-1) of different shape and/or size and/or different overlap between adjacent patches (see non-overlapping patches 25 and partially overlapping patches 26).

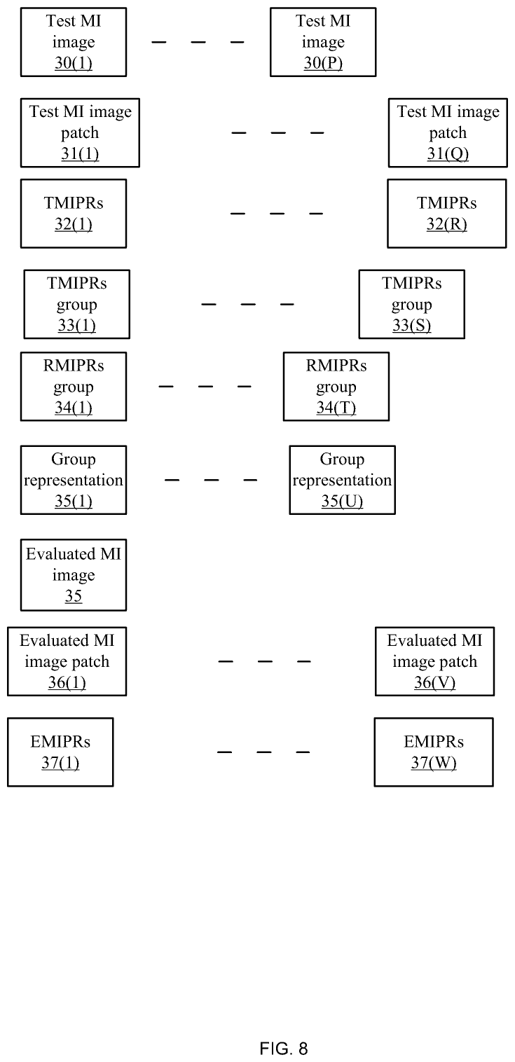

FIG. 8 illustrates examples of images and data structures such as test images 30(1)-30(P), test MI image patches 31(1)-31(Q), TMIPRs 32(1)-32(R), TMIPRs groups 33(1)-32(S), RMIPRs groups 34(1)-34(T) that are selected from the TMIPRs groups, group representations 35(1)-35(U) of the RMIPRs groups, an evaluated MI image 35, evaluated MI image patches 36(1)-36(V) and EMIPRs 37(1)-37(W). P, Q, R, S, T, U, V and W may have any values.

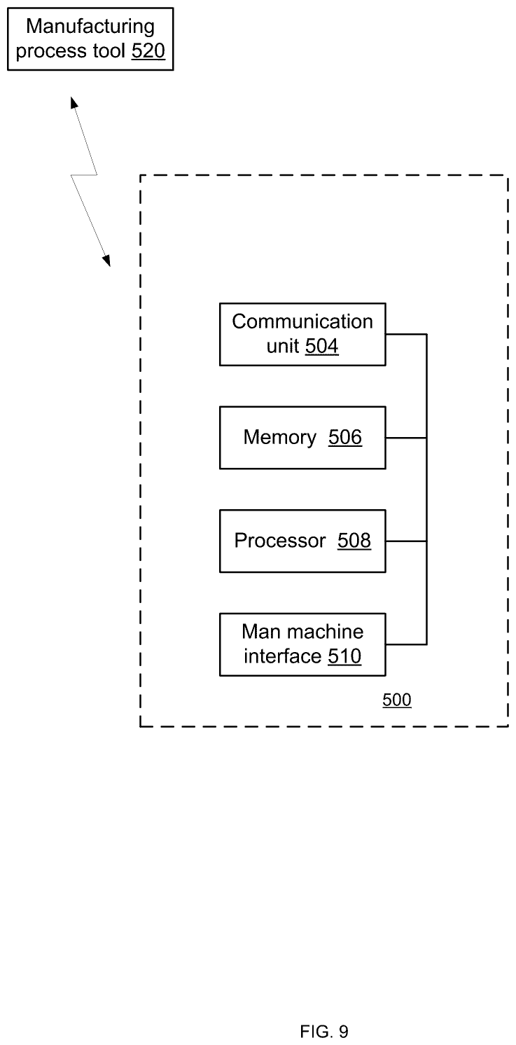

FIG. 9 is an example of a computerized system 500.

The computerized system 500 may execute method 100 and/or method 200.

The computerized system 500 may or may not communicate with the manufacturing process tool 520—for example to provide feedback about the manufacturing process applied by the manufacturing process tool 520 (that manufactured the evaluated manufactured items) and/or for receiving images of the evaluated manufactured items, and the like. The computerized system 500 may be included in the manufacturing process tool 520.

The computerized system 500 may or may not communicate with a person (such as an operator of the manufacturing process tool 520, or any other person authorized to perform manufacturing process decisions).

The computerized system 500 may include a communication unit 504, memory 506, processor 508 and may optionally include a man machine interface 510.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as flash memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for detecting faulty manufactured items, the method comprises:
obtaining an evaluated manufactured item (MI) image;
segmenting the image of the evaluated MI to provide different groups of evaluated MI patches, wherein evaluated MI patches of the different groups of evaluated MI patches differ from each other by one or more evaluated MI patch generation attribute;
generating evaluated MI patches representations (EMIPRs) for the evaluated MI patches of the different groups of evaluated MI patches;
matching the EMIPRs to reference MI patches representations (RMIPRs) of reference MI patches, to provide comparison results; wherein the reference MI patches are selected from reference MI patches candidates, based on at least one of (a) a popularity of reference MI patch candidates representations or (b) feedback from a person; wherein reference MI patches of the different groups of reference MI patches differ from each other by one or more reference MI patch attribute; and
determining a state of the evaluated manufactured item based on the comparison results.

2. The method according to claim 1 wherein the reference MI patches are selected based on the popularity of the reference MI patch candidates representations, and without receiving feedback from the person.

3. The method according to claim 1 wherein the reference MI patches are selected based on the feedback from the person and regardless of the popularity of reference MI patch candidates representations.

4. The method according to claim 1 wherein the reference MI patches are selected from reference MI patches candidates, by (a) determining, based on the popularity of reference MI patch candidates representations, popular reference MI patch candidates representations of the reference MI patch candidates representations, (b) providing to the person information regarding the popular reference MI patch candidates representations, (c) receiving feedback from the person regarding the popular reference MI patch candidates representations, and (d) selecting the reference MI patches based on the feedback.

5. The method according to claim 1, wherein the reference MI patch candidates are generated by:
receiving test images of test MIs;
segmenting the test images of the test MIs to provide test MI patches;
generating test MI patches representations (TMIPRs) that are reference MI patches candidates;
grouping the TIMPRs to provide TIMPRs groups;
selecting, out of the TIMPRs groups, reference MI patches representations (RIMPRs) groups, wherein the selecting is based on the at least one of (a) the popularity of the reference MI patch candidates representations or (b) the feedback from the person.

6. The method according to claim 5, wherein the test images are unlabeled.

7. The method according to claim 5 wherein the grouping comprises clustering the reference MI patch representations.

8. The method according to claim 5 wherein the matching comprises matching the evaluated MI patch representations to the RIMPR groups.

9. The method according to claim 1 wherein the determining of the state of the evaluated manufactured item comprising determining that the evaluated manufactured item is faulty when the comparison results indicate that there is at least a predefined number of evaluated MI patch representations that do match any of the reference MI patch representations.

10. The method according to claim 1 wherein the matching is executed regardless of a location of the reference MI patch.

11. The method according to claim 1 wherein at least two of the different groups of MI patches cover an entirety of the evaluated manufactured item.

12. The method according to claim 1 wherein the one or more evaluated MI patch generation attribute is an evaluated MI patch size.

13. The method according to claim 1 wherein the one or more evaluated MI patch generation attribute is an evaluated MI patch shape.

14. The method according to claim 1 wherein the one or more evaluated MI patch generation attribute is an overlap evaluated MI patch between adjacent MI patch representations.

15. The method according to claim 1 wherein there at least three different groups of MI patch representations.

16. The method according to claim 1 wherein the evaluated MI patch representations comprise features of one or more layer of a neural network.
